(19) United States
(12) Patent Application Publication
(10) Pub. No.: US 2021/0190466 A1
(43) Pub. Date: Jun. 24, 2021

(54) Waterproof Housing System for Tape Measures

(71) Applicant: Tony Caputo, North Vancouver (CA)

(72) Inventor: Tony Caputo, North Vancouver (CA)

(21) Appl. No.: 16/722,108

(22) Filed: Dec. 20, 2019

(51) Int. Cl. G01B 3/1041

(52) U.S. Cl. CPC G01B 3/1041

(57) ABSTRACT

The present invention is a waterproof housing system for use with an existing tape measure housing including a sleeve, a pair of congruent bands integral with the sleeve and a watertight tape slot formed in the sleeve.

### BACKGROUND OF THE INVENTION

Persons in construction, landscaping, and other professions which would include every trade that does any work outdoors are well-aware that they will go through multiple tape measures a year due to water, debris, and other damage caused by the elements. Tape measures quickly degrade once any form of water is trapped in the housing, rendering them useless only a few days after water has had time to sit within the housing. Although it might seem trivial to some, it is undesired and does cause significant expense over time. These persons are constantly seeking a solution to this problem.

The present invention successfully addresses this need.

### SUMMARY OF THE INVENTION

The present invention is a waterproof housing configured to seal the protective housing of traditional coiled form measuring tapes (e.g. tape measures).

In one embodiment, a silicon/rubber gasket contacts the tape, eliminating the gap of the tape measures protective housing entrance. It is constructed and arranged to be precise enough to still allow the tape ribbon to extend and retract, while preventing water and debris from entering the housing entrance when the ribbon is retracted.

In one embodiment, the present invention protects the internal housing of a measuring tape from water and debris, which prevents fouling of the internal mechanism. This protection increases tape measure longevity and useful life.

Additionally, the present invention allows measuring tapes to be used in the rain.

In one embodiment, the present invention is a universal housing configured for use on multiple different tape measure styles and brands

In one embodiment, the present invention is constructed with a rubber and/or plastic/silicon with sufficient elasticity to stretch around the tape measure to keep it secure.

The material needs to be weather resistant since it will be used outside in working conditions.

In one embodiment, the material of the front plate that houses the slit where the tape expands/contracts needs to be precise enough to keep water out, but not too tight otherwise the tape will not slide smoothly

In one embodiment, there are two bands attached to a single front plate that houses a single opening for the tape to contract through. This would include a top band and a bottom band. The bottom band would wrap around the base of the tape measure, upper, or top band would wrap around the mid section of the tape measure, keeping the front plate pressed firmly against the tape.

In one embodiment, a front plate would just be large enough to cover the entrance of the tape measure housing, with a single slit that the tape would run through.

This front plate is configured for several functions.

The front plate will keep the inner mechanism dry when the expanded tape is exposed to water.

The front plate will keep the tape dry upon contraction back into the housing.

The front plate will provide a universal product that could be used on multiple different tape measures of similar band size The front plate will increase the longevity of a tape measure by eliminating the chance of the internal housing rusting due to water damage.

In one embodiment, the present invention is a waterproof housing system configured for use with an existing tape measure housing having a measuring tape housed therein, said system comprising:
a sleeve;
a pair of congruent bands integral with said sleeve;
a watertight tape slot formed in said sleeve.

In one embodiment, the pair of congruent bands are formed of rubber, silicon, plastic, or combinations thereof and are constructed with elasticity to attach to said existing tape measure housing in a taut manner.

In one embodiment, the watertight tape slot is constructed and arranged to permit said measuring tape selectively moved from retracted to extended configurations as desired while maintaining a watertight seal around said measuring tape.

In one embodiment, the present invention is a waterproof housing system configured for use with an existing tape measure housing having a measuring tape housed therein, said system consisting essentially of:
a sleeve;
a pair of congruent bands integral with said sleeve, said bands formed of rubber, silicon, plastic, or combinations thereof and are constructed with elasticity to attach to said existing tape measure housing in a taut manner;
a watertight tape slot formed in said sleeve, whereby said watertight tape slot is constructed and arranged to permit said measuring tape selectively moved from retracted to extended configurations as desired while maintaining a watertight seal around said measuring tape.

### BRIEF DESCRIPTION OF THE SEVERAL VIEWS OF THE DRAWINGS

FIG. 1 is a side perspective and separated view of a tape measure housing and housing of the present invention.

FIG. 2 is a side connected view of a tape measure housing and housing of the present invention.

FIG. 3 is a top view of a tape measure housing and housing of the present invention.

FIG. 4 is a front connected view of a tape measure housing and housing of the present invention.

FIG. 5 is a rear view of a housing of the present invention.

### DETAILED DESCRIPTION OF THE PREFERRED EMBODIMENT

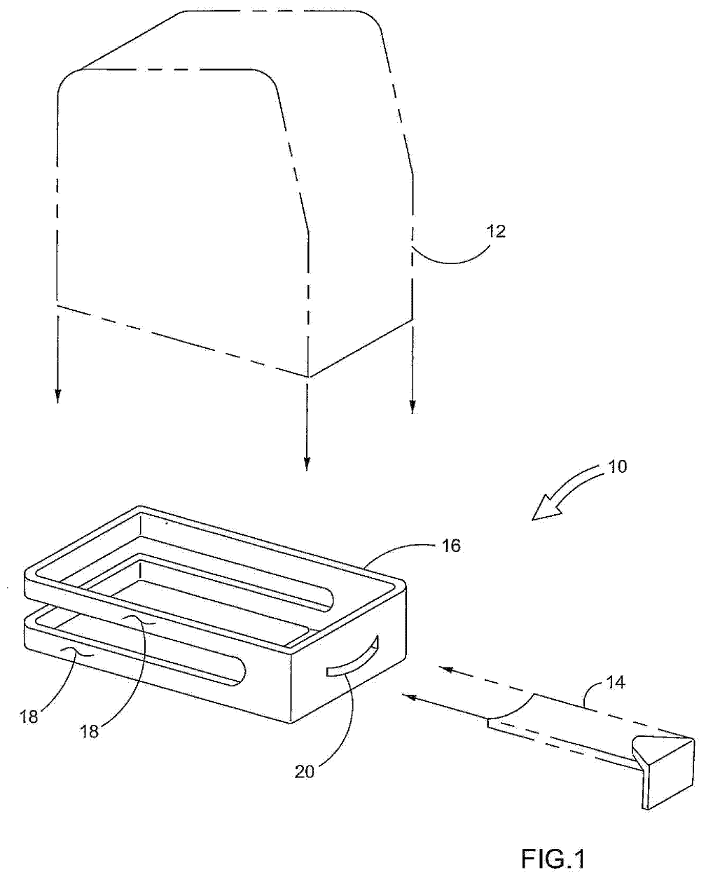

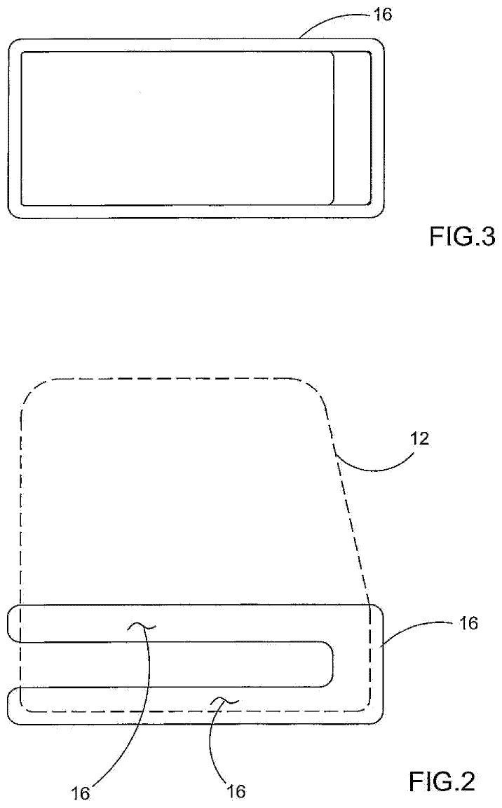

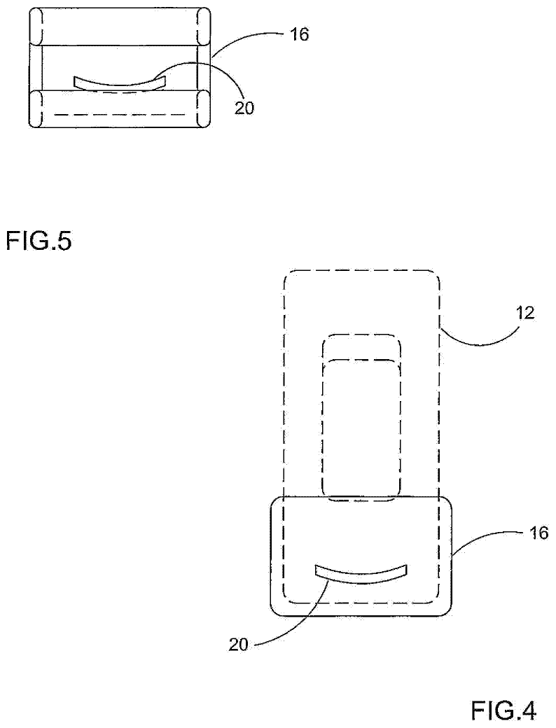

As generally understood, the present invention provide a system 10 constructed and arranged to be used with an existing measuring tape housing 12. The existing measuring tape housing 12 as is commonly known, has measuring tape 14 extendable and retractable from within housing 12. A waterproofing sleeve 16 has formed there with a pair of sidebands 18. As demonstrated in FIGS. 1 and 2 Side bands 18 include an upper or top sideband and lower or bottom sideband that are congruent on to another. Sidebands 18 are formed of an elastic material including rubber, silicon, synthetic materials, or combinations thereof. The sidebands 18 are constructed and arranged such that the ecstaticity imparts a taut fit about the outer perimeter of tape measure housing 12.

Waterproofing sleeve has formed there in tape slot 20 which is a constructed and arranged to provide a watertight sleeve surrounding measuring tape 14. In forming the invention with the watertight tape slot 20, the invention protects the inner components within tape measure housing 12 from water debris and the like.

In use, an existing tape measure is affixed to the housing such that the tape is accessible to extend and contract through the tape slot. Then, a user will extend and retract the tape as desired while the internal mechanism remains protected.

On significant advantage of the present invention is that is it constructed and arranged to be operable with existing tape measures. In configuring the invention as such, the invention is readily accessible on a large scale and does not require current tape measure manufacturers to alter their current products.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A waterproof housing system configured for use with an existing tape measure housing having a measuring tape housed therein, said system comprising:
a sleeve;
a pair of congruent bands integral with said sleeve;
a watertight tape slot formed in said sleeve.

2. The system of claim 1 wherein said pair of congruent bands are formed of rubber, silicon, plastic, or combinations thereof and are constructed with elasticity to attach to said existing tape measure housing in a taut manner.

3. The system of claim 1 wherein said watertight tape slot is constructed and arranged to permit said measuring tape selectively moved from retracted to extended configurations as desired while maintaining a watertight seal around said measuring tape.
